(19) United States
(12) Patent Application Publication
(10) Pub. No.: US 2002/0054405 A1
(43) Pub. Date: May 9, 2002

(54) Extensions to resource reservation protocol (RSVP) -traffic engineering (TE) for bi-directional optical path setup

(76) Inventors: Duanyang Guo, San Diego, CA (US); Leah Zhang, Holmdel, NJ (US)

Correspondence Address: Brobeck, Phleger & Harrison, LLP, 12390 El Camino Real, San Diego, CA, 92130, US

(21) Appl. No.: 09/779,011

(22) Filed: Feb. 9, 2001

Related U.S. Application Data
(60) Provisional application No. 60/218,359, filed on Jul. 13, 2000.

(51) Int. Cl. H04B 10/20; H04J 14/00; G02B 6/28

(52) U.S. Cl. 359/118; 359/119; 385/24

(57) ABSTRACT

A method of providing bi-directional optical switched paths in an optical network includes the allocation of a pair of labels for uni-directional optical paths in a backward direction and in a forward direction. The forward and backward going optical paths of a given optical node are either both outgoing paths from the given optical node or both incoming paths toward the given optical node. The provision of bi-directional optical switched paths can be implemented as an extension to the Resource Reservation Protocol-Traffic Engineering (RSVP-TE) while avoiding the problem of contention for label allocation.

### CROSS REFERENCE TO RELATED APPLICATION

This application claims the benefit of U.S. Provisional Application Serial No. 60/218,359, filed Jul. 13, 2000.

### BACKGROUND OF THE INVENTION

1. Field of the Invention

The present invention relates to internet a communications, and more particularly, to internet communications in optical networks.

2. Background Art

A large number of documents including requests for comments and internet drafts proposing standards for internet routing and switching operations in optical fiber communications networks have been proposed to the Internet Engineering Task Force (IETF). Certain standards have been defined and accepted by the telecommunications industry on the Resource Reservation Protocol (RSVP), and more particularly, Resource Reservation Protocol-Traffic Engineering (RSVP-TE). Some of the documents which have been submitted to the IETF in areas related to RSVP-TE include Braden, et al., “Resource Reservation Protocol (RSVP)-Version 1 Functional Specification,” Request For Comments 2205, Internet Engineering Task Force, September 1997; Awduche, et al., “Multi-Protocol Lambda Switching: Combining MPLS Traffic Engineering Control With Optical Crossconnects,” Internet Draft, Internet Engineering Task Force, July 2000; Awduche, et al., “RSVP-TE: Extensions to RSVP for LSP Tunnels,” Internet Draft, Internet Engineering Task Force, February 2000; Lang, et al., “Extensions to RSVP for Optical Networking,” Internet Draft, Internet Engineering Task Force, March 2000; and Saha et al., “RSVP Extensions for Signaling Optical Paths,” Internet Draft, Internet Engineering Task Force, March 2000, all of which are incorporated herein by reference.

It is desirable to provision bi-directional end-to-end optical paths in optical networks operated by telecommunications carriers and competitive local exchange carriers (CLECs). The need to provision bi-directional end-to-end optical paths is driven largely by the requirement of traffic symmetry in the networks. Conventional schemes have been devised which include setting up two uni-directional paths between two end points of a network as an equivalent of a bi-directional optical path.

However, setting up two uni-directional paths between two end points may have several drawbacks. First, two uni-directional paths may follow two different physical fiber routes. Furthermore, there is typically a time gap for setting up two uni-directional paths between two end points. This time gap may introduce a race condition for resources, thereby resulting in a possible deadlock. When a deadlock occurs, the network may have to abort the setup of the bi-directional path using the conventional scheme of setting up two uni-directional paths. Even if the two uni-directional paths are established successfully as an equivalent of a bi-directional path using conventional schemes, longer setup latency may be needed, thereby resulting in slower connection times for the network end points.

Therefore, there is a need for an improved method of setting up bi-directional optical paths in optical networks.

### SUMMARY OF THE INVENTION

The present invention provides a method of providing bi-directional optical switched paths in an optical network, an embodiment of which generally comprises the steps of:

providing a label request object for at least one bi-directional optical switched path (BOSP) tunnel;

providing a label object for said at least one BOSP tunnel;

detecting a reservation (RESV) message for said at least one BOSP; and

allocating a pair of labels for a first outgoing path in a backward direction and for a second outgoing path in a forward direction upon detecting the RESV message.

In an alternate embodiment, a pair of labels are allocated for incoming paths in a backward direction and in a forward direction instead of the outgoing paths. In an embodiment, the label request object and the label object for the BOSP tunnel are implemented as an extension to a conventional RSVP-TE protocol which is known to a person skilled in the art, thereby avoiding major changes to existing protocols in order to implement truly bi-directional optical switched paths.

### BRIEF DESCRIPTION OF THE DRAWINGS

The present invention will be described with particular embodiments thereof, and references will be made to the drawings in which:

FIG. 1 shows a typical optical ring network in which the method for bi-directional optical path setup is applicable; and

FIG. 2 shows a portion of the optical ring network with three adjacent nodes including an initiating node and a responding node for which the method of bi-directional optical path setup is applicable.

### DETAILED DESCRIPTION

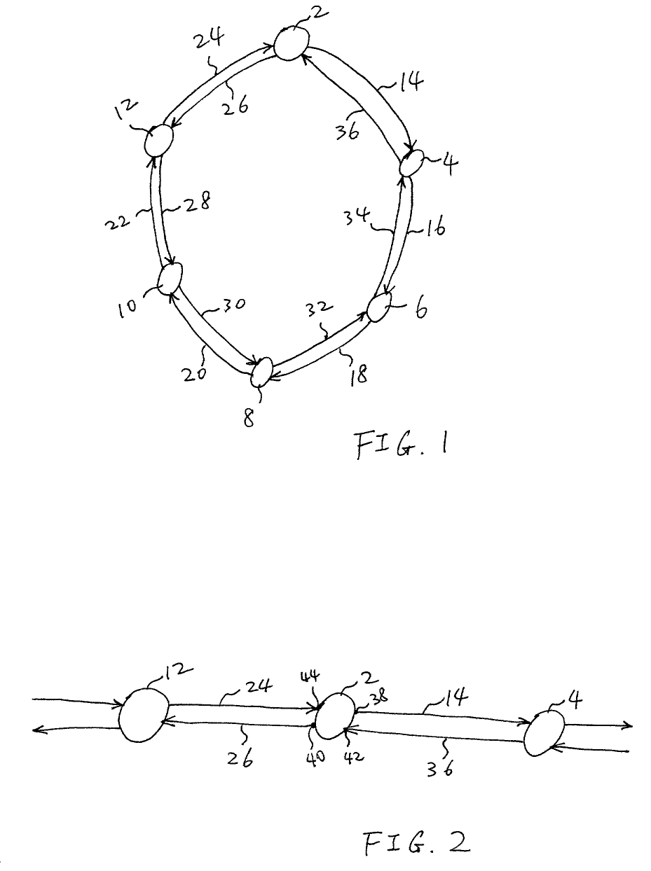

FIG. 1 shows a typical optical ring network having optical nodes 2, 4, 6, 8, 10 and 12. Any one of the optical nodes may also serve as a node in another optical network. In an embodiment, each of the optical nodes comprises an optical router which includes an optical cross-connect (OXC) system. Typical examples of an OXC include an optical multiplexing-demultiplexing system with a plurality of optical switch arrays and optical add-drop multiplexers with an optical switching fabric. The method of bi-directional optical path setup according to embodiments of the present invention is applicable to various types of optical nodes and is not limited to particular types of physical devices implemented in the OXCs.

Between a pair of adjacent optical nodes within an optical ring network, two optical paths are implemented to provide physical optical channels for communications in opposite directions. In a typical optical fiber communications network, at least two optical fibers are connected between two adjacent nodes to provide optical channels for signal flows in both directions. The method of bi-directional optical path setup according to embodiments of the present invention is not limited, however, to physical implementations with optical fibers providing the signal paths. The type of physical connection between adjacent optical nodes in an optical ring network is not critical to the method for bi-directional optical path setup.

Referring to FIG. 1, an optical path 14 is set up between the optical nodes 2 and 4 for optical signal flow in a clockwise direction. In a similar manner, optical paths 16, 18, 20, 22 and 24 are provided between pairs of adjacent optical nodes 4 and 6, 6 and 8, 8 and 10, 10 and 12, and 12 and 2 in the clockwise direction. In a counterclockwise direction, optical paths 26, 28, 30, 32, 34 and 36 are provided between pairs of adjacent optical nodes 2 and 12, 12 and 10, 10 and 8, 8 and 6, 6 and 4, and 4 and 2, respectively. Traffic engineering protocols including the Resource Reservation Protocol-Traffic Engineering (RSVP-TE) have been proposed as industry standards to the Internet Engineering Task Force (IETF). Conventional schemes of optical traffic engineering according to the RSVP are described in the IETF documents cited in the Background and incorporated by reference in this application.

FIG. 2 shows three adjacent optical nodes 12, 2 and 4 as part of the optical ring network of FIG. 1. Referring to FIG. 2, the physical connections between adjacent optical nodes 2 and 12 are provided by a first optical path 24 in the direction from the optical node 12 to the optical node 2 and a second optical path 26 in the direction from the optical node 2 to the optical node 12. In a similar manner, the physical connections between adjacent optical nodes 2 and 4 are provided by a first optical path 14 in the direction from the optical node 2 to the optical node 4 and a second optical path 36 in the direction from the optical node 4 to the optical node 2. The method for bi-directional optical path setup according to embodiments of the present invention is applicable to bi-directional optical communications between any of the optical nodes in an optical ring network, such as the adjacent optical nodes 12, 2 and 4 as shown in FIG. 2.

In an embodiment, the method for bi-directional path setup is implemented as an extension to the RSVP-TE. More particularly, this extension to RSVP-TE is suitable for setting up and maintaining bi-directional optical switched paths (BOSPs) in optical networks with symmetric traffic patterns. The setup follows the framework of industry-standard multi-protocol label switching (MPLS) and extends the RSVP-TE to support the signaling for the provisioning of BOSPs. In an embodiment, a new C-type for bi-directional label switched paths (LSPs) is introduced which includes a label request object and a label object.

For each link state routing (LSR), an optical node which includes an OXC will allocate a pair of labels, one for an outgoing port going forward and the other for another outgoing port going backward, upon detecting a reservation (RESV) message for a BOSP. In an embodiment, the label object includes a fiber identification (fiber ID), a wavelength identification (wavelength ID) and a sub-channel identification (sub-channel ID), if applicable, for each of the outgoing ports of the OXC.

In an alternate embodiment, a pair of labels are allocated upon detecting an RESV message for an incoming port going backward and for another incoming port going forward. The allocation of object labels are either for both outgoing ports or for both incoming optical ports of an OXC. The extension requires only a slight change to the existing RSVP-TE protocol while avoiding a potential problem of contention for label allocation. As a result, this extension is capable of obviating the need for additional mechanisms of contention resolution.

Referring to FIG. 2, a path message is initiated by one of the optical nodes, such as the optical node 4, and forwarded to another optical node, such as the optical node 12. A bi-directional path is formed by the combination of the uni-directional optical paths 24 and 14 through the intermediary optical node 2 and the uni-directional paths 36 and 26 through the intermediary optical node 2 in an opposite direction. The optical node 4 which initiates the path message is called the initiating optical node. A bi-directional label request is included in the path message. Upon receiving the path message, the optical node 2 records the bi-directional label request into its path state block (PSB).

An RESV message is initiated by the optical node 12 which is positioned on the bi-directional path opposite the initiating optical node 4. The RESV message is transmitted by the optical node 12, which is called the responding optical node, to the initiating optical node 4 through the intermediary optical node 2 along the bi-directional path.

The intermediary optical node 2, upon receiving the RESV message, assigns labels to outgoing uni-directional links 14 and 26, one of which is directed toward the initiating optical node 4 and the other one of which is directed toward the responding optical node 12. From the point of view of the optical node 2, both optical paths 14 and 26 are uni-directional links in outgoing directions. The uni-directional optical path 14 from the intermediary optical node 2 to the initiating optical node 4 may be regarded as an outgoing path in a forward direction, whereas the other uni-directional optical path 26 from the intermediary optical node 2 to the responding optical node 12 may be regarded as an outgoing path in a backward direction from the point of view from the optical node 2.

In an alternate embodiment, the intermediary optical node 2, upon receiving the RESV message, assigns two labels for two incoming uni-directional links 36 and 24 from the initiating optical node 4 and the responding optical node 12, respectively. The optical path 36 may be regarded as an incoming uni-directional link in a forward direction whereas the optical path 24 may be regarded as an incoming uni-directional link in a backward direction from the point of view of the optical node 2. Furthermore, to avoid a potential deadlock, the allocation of labels is atomic, that is, either both labels are assigned or no label is assigned.

In an embodiment, the assignment of labels is carried out by a label manager for the optical node 2. The pair of labels, which include the port, wavelength and sub-channel identifications either for the forward and backward outgoing paths or for the forward and backward incoming paths, are assigned by taking into consideration of factors such as the availability of outgoing or incoming ports, bandwidth constraints, and whether a wavelength conversion is allowed. If the network requires wavelength continuity for one of the optical channels, then wavelength conversion is not allowed for that optical channel.

Because none of the uni-directional optical paths is capable of acting as an outgoing link for two optical nodes, it is at least theoretically impossible to have two optical nodes engaged in a contention. In an embodiment in which a pair of labels are assigned for two incoming uni-directional optical paths, none of the optical paths can act as an incoming link for two optical nodes. It is therefore also at least theoretically impossible for two optical nodes to engage in a contention. Because no additional mechanism is needed to resolve the problem of potential contention, the complexity of providing an extension to the RSVP-TE for setting up and maintaining BOSPs is greatly reduced.

If no label can be assigned due to resource constraint or other reasons, such as rejection by policy control, an RESV error message (RESV-Err) is transmitted by the optical node 2 and propagated toward the responding optical node 12. The RESV-Err message then triggers the tearing down of the labels already allocated, thereby causing the session to fail. Furthermore, an RESV tear message and a path tear message are generated by the optical node 2 to tear down the bi-directional optical path setup. The RESV tear message deletes the reserved labels for optical links in both forward and backward directions and travels toward the initiating optical node 4. The path tear message travels to the responding optical node 12 and deletes the path state as well as dependent reservation state along the way.

The path tear and RESV tear messages may be conceptualized in an embodiment as reversed path and RESV messages, respectively. In the embodiment in which both the forward and backward going optical paths are incoming paths, the RESV tear message and the path tear message operate to delete the pair of labels as well as the path state and the dependent reservation state along the optical paths in a similar manner. The setting up and the tearing down of bi-directional optical links using a pair of labels as an extension to the RSVP-TE are applicable to any of the optical nodes in the optical ring network as shown in FIG. 1.

In an embodiment, a C-type is introduced for bi-directional LSP in both the path messages and the RESV messages. When each optical node receives an RESV message, it allocates two labels, one for a first outgoing optical port toward the initiating optical node and the other for a second outgoing optical port toward the responding optical node. For example, referring to FIG. 2, the optical node 2 has a first outgoing optical port 38 which is connected to the outgoing optical path 14 in a forward direction toward the initiating optical node 4, and a second outgoing optical port 40 which is connected to the outgoing optical path 26 in a backward direction toward the responding optical node 12.

Alternatively, a pair of labels may be assigned for two incoming optical ports 42 and 44 of the optical node 2 connected to the incoming optical path 36 in a forward direction from the initiating optical node 4 and the incoming optical path 24 in a backward direction from the responding optical node 12, respectively. The pair of labels are referred to the object containing information including the fiber ID, the wavelength ID and the sub-channel ID, if applicable.

In an embodiment, a new C-type for a label request object is defined as follows:

```
0 1 2 3
0 1 2 3 4 5 6 7 8 9 0 1 2 3 4 5 6 7 8 9 0 1 2 3 4 5 6 7 8 9 0 1
+−+−+−+−+−+−+−+−+−+−+−+−+−+−+−+−+−+−+−+−+−+−+−+−+−+−+−+−+−+−+−+−
|Reserved | L3PTD |
            Minimum Port# Maximum Port# |
            Minimum Wavelength# Maximum Wavelength# |
            Minimum Subchannel# Maximum Subchannel# |
```

Furthermore, a new C-type is added to the label object. In an embodiment, the label object has the following format:

0 1 2 3
0 1 2 3 4 5 6 7 8 9 0 1 2 3 4 5 6 7 8 9 0 1 2 3 4 5 6 7 8 9 0 1
+−+−+−+−+−+−+−+−+−+−+−+−+−+−+−+−+−+−+−+−+−+−+−+−+−+−+−+−+−+−+−+−
| |
// (object contents) //
| |
+−+−+−+−+−+−+−+−+−+−+−+−+−+−+−+−+−+−+−+−+−+−+−+−+−+−+−+−+−+−+−+−
| Port ID1 |
+−+−+−+−+−+−+−+−+−+−+−+−+−+−+−+−+−+−+−+−+−+−+−+−+−+−+−+−+−+−+−+−
| Wavelength ID1 |
+−+−+−+−+−+−+−+−+−+−+−+−+−+−+−+−+−+−+−+−+−+−+−+−+−+−+−+−+−+−+−+−
| Sub−channel ID1 |
+−+−+−+−+−+−+−+−+−+−+−+−+−+−+−+−+−+−+−+−+−+−+−+−+−+−+−+−+−+−+−+−
| Port ID2 |
+−+−+−+−+−+−+−+−+−+−+−+−+−+−+−+−+−+−+−+−+−+−+−+−+−+−+−+−+−+−+−+−
| Wavelength ID2 |
+−+−+−+−+−+−+−+−+−+−+−+−+−+−+−+−+−+−+−+−+−+−+−+−+−+−+−+−+−+−+−+−
| Sub−channel ID2 |
+−+−+−+−+−+−+−+−+−+−+−+−+−+−+−+−+−+−+−+−+−+−+−+−+−+−+−+−+−+−+−+−

In the label object, Port ID1, Wavelength ID1 and Sub-channel ID1 are port, wavelength and sub-channel assignments, respectively, for an outgoing or incoming optical path in a forward direction, whereas Port ID2, Wavelength ID2 and Sub-channel ID2 are port, wavelength and sub-channel assignments, respectively, for the outgoing or incoming optical path in a backward direction. As described above, the forward and backward optical paths are either both outgoing or both incoming to avoid the potential problem of path contention.

In these embodiments, it is assumed that an ingress optical node is both a sender and a receiver of the same traffic class, and that all physical optical channels are uni-directional. In an embodiment, at each optical node, a table is provided which contains information as to how a uni-directional optical fiber in a forward direction is paired to another uni-directional fiber in a backward direction. In a further embodiment, this table also includes information on the adjacency of the optical nodes and how the optical ports are connected to the neighbors of each optical node. This table may be dynamically updated as the port, wavelength or sub-channel assignments may change over time because of optical switching or add-drop multiplexing operations by the OXCs in the optical nodes.

The present invention has been described with respect to particular embodiments thereof, and numerous modifications can be made which are within the scope of the invention as set forth in the claims.

What is claimed is:

1. A method of providing bi-directional optical switched paths in an optical network, the method comprising the steps of:
providing a label request object for at least one bi-directional optical switched path (BOSP) tunnel;
providing a label object for said at least one BOSP tunnel;
detecting a reservation (RESV) message for said at least one BOSP; and
allocating a pair of labels for a first outgoing path in a backward direction and for a second outgoing path in a forward direction upon detecting the RESV message.

2. The method of claim 1, wherein the pair of labels include a first fiber identification (fiber ID) for the first outgoing path and a second fiber ID for the second outgoing path.

3. The method of claim 1, wherein the pair of labels include a first wavelength identification (wavelength ID) for the first outgoing path and a second wavelength ID for the second outgoing path.

4. The method of claim 1, wherein the pair of labels include a first sub-channel identification (sub-channel ID) for the first outgoing path and a second sub-channel ID for the second outgoing path.

5. The method of claim 1 for communication between a plurality of optical nodes, further comprising the step of transmitting a path message by a first one of the nodes.

6. The method of claim 5, further comprising the step of transmitting the RESV message by a second one of the nodes.

7. The method of claim 6, wherein the steps of detecting the RESV message and allocating the pair of labels are performed by a third one of the nodes connected between the first node and the second node.

8. The method of claim 7, further comprising the step of providing a bi-directional label request for the third node upon receiving the path message.

9. The method of claim 8, further comprising the step of recording the bi-directional label request into a path state block (PSB) by the third node.

10. The method of claim 8, further comprising the steps of:
determining whether the pair of labels can be assigned for the first and second outgoing paths; and
transmitting an RESV error message to the second node in response to the step of determining that the pair of labels cannot be assigned.

11. The method of claim 8, further comprising the step of transmitting a path tear message and a RESV tear message to delete the pair of labels.

12. The method of claim 5, wherein the optical nodes comprise routers.

13. The method of claim 12, wherein the routers comprise optical cross-connects (OXCs).

14. The method of claim 1, wherein the label request object includes a minimum port number, a maximum port number, a minimum wavelength number, a maximum wavelength number, a minimum sub-channel number, and a maximum sub-channel number.

15. The method of claim 1, wherein the pair of labels are allocated as an extension to resource reservation protocol-traffic engineering (RSVP-TE).

16. A method of providing bi-directional optical switched paths in an optical network, the method comprising the steps of:
providing a label request object for at least one bi-directional optical switched path (BOSP) tunnel;
providing a label object for said at least one BOSP tunnel;
detecting a reservation (RESV) message for said at least one BOSP; and
allocating a pair of labels for a first incoming path in a backward direction and for a second incoming path in a forward direction upon detecting the RESV message.

17. The method of claim 16, wherein the pair of labels include a first fiber identification (fiber ID) for the first incoming path and a second fiber ID for the second incoming path.

18. The method of claim 16, wherein the pair of labels include a first wavelength identification (wavelength ID) for the first incoming path and a second wavelength ID for the second incoming path.

19. The method of claim 16, wherein the pair of labels include a first sub-channel identification (sub-channel ID) for the first incoming path and a second sub-channel ID for the second incoming path.

20. The method of claim 16 for communication between a plurality of optical nodes, further comprising the step of transmitting a path message by a first one of the nodes.

21. The method of claim 20, further comprising the step of transmitting the RESV message by a second one of the nodes.

22. The method of claim 21, wherein the steps of detecting the RESV message and allocating the pair of labels are performed by a third one of the nodes connected between the first node and the second node.

23. The method of claim 22, further comprising the step of providing a bi-directional label request for the third node upon receiving the path message.

24. The method of claim 23, further comprising the step of recording the bi-directional label request into a path state block (PSB) by the third node.

25. The method of claim 23, further comprising the steps of:
determining whether the pair of labels can be assigned for the first and second incoming paths; and
transmitting an RESV error message to the second node in response to the step of determining that the pair of labels cannot be assigned.

26. The method of claim 23, further comprising the step of transmitting a path tear message and a RESV tear message to delete the pair of labels.

27. The method of claim 20, wherein the optical nodes comprise routers.

28. The method of claim 27, wherein the routers comprise optical cross-connects (OXCs).

29. The method of claim 16, wherein the label request object includes a minimum port number, a maximum port number, a minimum wavelength number, a maximum wavelength number, a minimum sub-channel number, and a maximum sub-channel number.

30. The method of claim 16, wherein the pair of labels are allocated as an extension to resource reservation protocol-traffic engineering (RSVP-TE).
